(19) United States
(12) Patent Application Publication
(10) Pub. No.: US 2022/0153408 A1
(43) Pub. Date: May 19, 2022

(54) DRAGONFLY-LIKE MINIATURE FOUR-WINGED ORNITHOPTER

(71) Applicant: ZHEJIANG UNIVERSITY, Hangzhou (CN)

(72) Inventors: Yao ZHENG, Hangzhou (CN); Guanghua SONG, Hangzhou (CN); Changping DU, Hangzhou (CN); Bowei YANG, Hangzhou (CN); Zhixian YE, Hangzhou (CN); Rui YANG, Hangzhou (CN); Junyin CHEN, Hangzhou (CN); Zekun ZHANG, Hangzhou (CN); Sipeng WANG, Hangzhou (CN); Jianfu HAN, Hangzhou (CN)

(21) Appl. No.: 17/435,349

(22) PCT Filed: May 20, 2020
(86) PCT No.: PCT/CN2020/091348

§ 371 Date: Aug. 31, 2021

(30) Foreign Application Priority Data
May 20, 2019 (CN) 201910420547.X

(51) Int. Cl. B64C 33/02; B64C 39/02

(52) U.S. Cl. CPC B64C 33/025; B64C 2201/102; B64C 2201/025; B64C 39/024

(57) ABSTRACT

A dragonfly-like miniature four-winged ornithopter includes: a fuselage (101), two front flapping wings (102), two front wing connectors (103) with first connecting rods, two rear flapping wings (104), two rear wing connectors (105) with second connecting rods, a driving gear (106), a shaft gear (107), a first-stage gear (108), two second-stage gears (109) with third connecting rods, two third-stage gears (114) with fourth connecting rods, two front ball joint connecting rods (110), two rear ball joint connecting rods (111), two steering engine connecting rods (112), two steer engines (113), and a brushless direct current motor.

### CROSS REFERENCE TO RELATED APPLICATION(S)

This application is a national stage application of International Patent Application No. PCT/CN2020/091348, filed on May 20, 2020, which claims priority of the Chinese Patent Application No. 201910420547.X, filed on May 20, 2019, both of which are incorporated by references in their entities.

### TECHNICAL FIELD

The present disclosure relates to a dragonfly-like miniature four-winged ornithopter.

### BACKGROUND ART

An ornithopter is a novel flight vehicle simulating the flying of birds or insects. Compared with a traditional fixed-wing or a rotary-wing vehicle, a power system and a control system of the ornithopter are integrated into one piece, and a flight control is integrated into a flapping system, therefore high mechanical efficiency is achieved. The micro ornithopter has high maneuverability through high-frequency flapping, twisting and other actions of flapping wings.

In terms of volume, the sizes of insects and birds are far smaller than those of conventional airplanes; during flight, the flapping frequency of the wing is high, the generated aerodynamic force is small but has obvious periodicity, and the flow field around the wing has the characteristics of small size and quick change. At present, the study on an ornithopter mainly focuses on an aerodynamic aspect of double-winged type single-degree-of-freedom flapping, and a flight mechanism of a four-winged type flapping wing is rarely studied and tested in depth.

### SUMMARY

The present disclosure aims to provide a dragonfly-like miniature four-winged ornithopter.

A technical solution of the dragonfly-like and four-winged micro ornithopter provided by the present disclosure includes a fuselage, two front flapping wings, two front wing connectors with first connecting rods, two rear flapping rings, two rear wing connectors with second connecting rods, a driving gear, a gear shaft, a first-stage gear, two second-stage gears with third connecting rods, two third-stage gears with fourth connecting rods, two front ball joint connecting rods, two rear ball joint connecting rods, two steering engine connecting rods, two steering engines, and a brushless direct current motor.

The brushless direct current motor and the driving gear are fixedly connected and mounted at one side of an outer surface of the fuselage. The first-stage gear is meshed with the driving gear. The gear shaft is connected with the first-stage gear. Two sides of the fuselage are respectively provided with the two second-stage gears engaged with the shaft gear, and respectively provided with the two third-stage gears which are engaged with the two second-stage gears respectively. Two front flapping wings are mounted at the two sides of the fuselage at a front part of the fuselage, and two rear flapping wings are mounted at the two sides of the fuselage at a rear part of the fuselage. Each front flapping wing has only one degree-of-freedom of flapping around a first shaft, and each rear flapping ring has two degree-of-freedom of flapping around a second shaft and flipping front and back;

On each side of the fuselage, one end of a front ball joint connecting rod on the side is connected with a first connecting rod of a front wing connector on the side, and another end of the front ball joint connecting rod is connected with a fourth connecting rod of a third-stage gear on the side; one end of a rear ball joint connecting rod on the side is connected with a second connecting rod of a rear wing connector on the side, and another end of the rear ball joint connecting rod is connected with a third connecting rod of a second-stage gear on the side; and one end of a steering engine connecting rod on the side is connected with a steering engine on the side, and another end of the steering engine connecting rod (112) is connected with the rear wing connector on the side.

Based on the above technical solution, in some embodiments, a gear ratio of the first-stage gear to the driving gear may be 54:20, a gear ratio of the second-stage gear to the shaft gear may be 64:8, and a gear ratio of the third-stage gear to the second-stage gear may be 1: 1.

In some embodiments, the ornithopter also includes a remote-control receiver, an electronic speed control, and a lithium battery. The electronic speed control may be connected with the lithium battery, the remote-control receiver and the brushless direct current motor. The angles of rotation of the rear flapping wings are controlled by steering engines through the steering engine connecting rods.

In some embodiments, the dragonfly-like and four-winged micro ornithopter is made of carbon fiber or synthetic resin materials.

The dragonfly-like and four-winged micro ornithopter provided by the present disclosure is light in total mass (as low as 50 g), is simple and compact in structure, and capable of achieving symmetric dragonfly-like flapping. A posture of the ornithopter is controlled by the steering engines, thereby achieving the control of complex motions, such as advancing, steering, ascending, descending, of the ornithopter.

### BRIEF DESCRIPTION OF THE DRAWINGS

The present disclosure will be further described below with reference to the accompanying drawings.

FIG. 1 is a schematic perspective view of a general structure of the present disclosure;

FIG. 2 is a schematic perspective view of a gear transmission structure; and

FIG. 3 is a diagram about flipping of two rear flapping wings of the flapping-wing mechanism.

### REFERENCE NUMERALS IN DRAWINGS

fuselage 101, front flapping wing 102, front wing connector 103 with a connecting rod, rear flapping wing 104, rear wing connector 105 with a connecting rod, driving gear 106, gear shaft 107, first-stage gear 108, second-stage gear 109 with a connecting rod, third-stage gear 114 with a connecting rod, front ball joint connecting rod 110, rear ball joint connecting rod 111, steering engine connecting rod 112, and steering engine 113.

### DETAILED DESCRIPTION OF THE EMBODIMENTS

The embodiment of the present disclosure will be described in detail below with reference to the accompanying drawings.

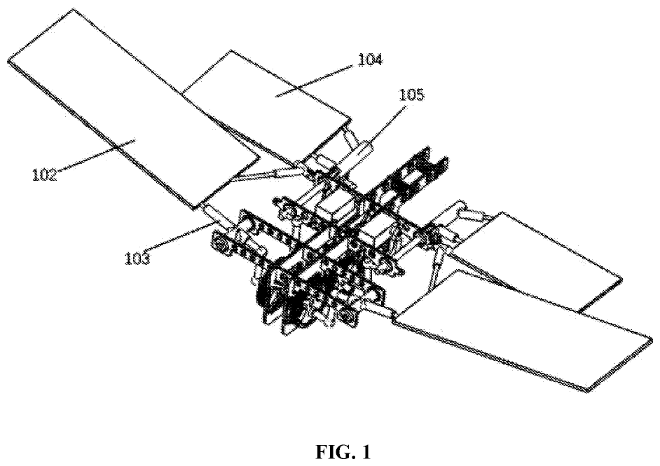

As shown in FIG. 1, a dragonfly-like miniature four-winged ornithopter includes a fuselage 101, two front flapping wings 102, two front wing connectors 103 with connecting rods, two rear flapping wings 104, two rear ring connectors 105 with connecting rods, a driving gear 106, a gear shaft 107, a first-stage gear 108, two second-stage gears 109 with connecting rods, two third-stage gears 114 with connecting rods, two front ball joint connecting rods 110, two rear ball joint connecting rods 111, two steering engine connecting rods 112, two steering engines 113, and a brushless direct current motor. The fuselage 101 is manufactured by 3D printing, the two front flapping wings 102 are connected to shaft holes of the front wing connectors 103 respectively, and the two rear flapping wings 104 are connected to two shaft holes of the two rear wing connectors 105 respectively; and a KV2200 motor with the model number of XXD1504 is selected as the brushless direct current motor.

The two steering engines 113 are mounted at two sides of a rear cantilever of the fuselage 101.

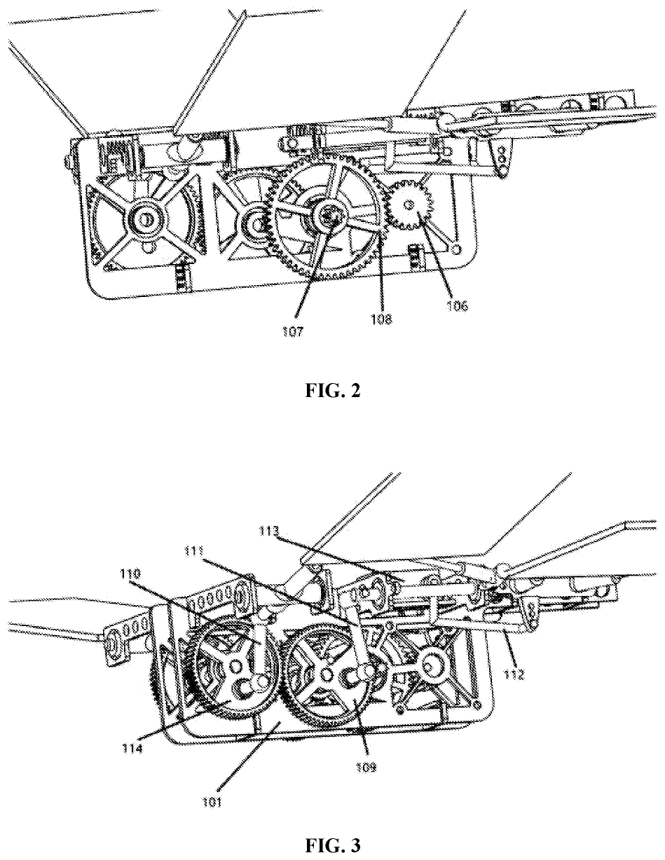

The brushless direct current motor is mounted at a position, close to a rear part, on a left side of the fuselage. As shown in FIG. 2, the driving gear 106 is mounted at an inner side of the fuselage 101, connected with the brushless direct current motor, and mesh with the first-stage gear 108. The gear shaft 107 and the first-stage gear 108 are coaxially fixed. The gear shaft 107 is meshed with the second-stage gears 109. A gear set is driven to rotate when the brushless direct current motor rotates, thereby driving the front flapping wings 102 and the rear flapping wings 104 to form flapping motion.

Gear parameters are shown in the following table.

| | Driving | First- | Gear | Second- | Third- |
|---|---|---|---|---|---|
| | gear | stage gear | shaft | stage gear | stage gear |
| Modulus | 0.5 | 0.4 | 0.4 | 0.4 | 0.4 |
| (mm) | | | | | |
| Number | 20 | 54 | 8 | 64 | 64 |
| of teeth | | | | | |

As show in FIG. 3, two sides of the fuselage 101 are respectively provided with the second-stage gears 109 with the connecting rods and respectively provided with the third-stage gears 114 with the connecting rods, and the second-stage gears 109 and the third-stage gears 114 are engaged with each other, with a transmission ratio of 1:1. On each side of the fuselage 101, a second-stage gear 109 and a third-stage gear 114 are respectively connected with a rear wing connector 105 and a front wing connector 103 through the respective ball joint connecting rods 111 and 110 to form two sets of crank-link mechanisms. When the two-stage gear 109 rotates, so that tail end of the rear wing connector 105 is driven to move up and down through the ball joint connecting rod 111, thereby enabling the rear flapping wing 104 to rotate around a mounting shaft on the fuselage 101. The third-stage gear 114 and the second-stage gear 109 are meshed and rotate simultaneously, so that tail end of the front wing connector 103 is driven to move up and down through the ball joint connecting rod 110, thereby enabling the front flapping wing 102 to rotate around a mounting shaft on the fuselage 101, thereby generating a flapping effect. The transmission ratio of the second-stage gear 109 to the third-stage gear 114 is 1:1, thereby guaranteeing the front flapping wing 102 and the rear flapping wing 104 to flap at the same frequency, where the frequency is rotating speeds of the second-stage gear and the third-stage gear. By adjusting the relative positions of the respective connecting rods on the second-stage gear and the third-stage gear during mounting, a phase difference of flapping periods of the front flapping wing and the rear flapping wing may be changed, thereby changing the aerodynamic force in the motion process.

The steering engines 113 are respectively mounted at the two sides of a rear part of the fuselage 101 and are respectively connected with the rear wing connectors 105 through the respective steering engine connecting rods 112. When the steering engines 113 rotate, the steering engine connecting rods 112 drive the rear wing connectors 105 to flip up and down, thereby achieving up-down flipping of the rear wings. When different signals are input, the rear flapping rings at the left side and the right side may rotate in accordance with the same direction or opposite directions, thereby adjusting the pitching and rolling of the ornithopter.

After the overall ornithopter is completely assembled, the remote-control flight of the ornithopter may be achieved by mounting an electronic device.

1.-6. (canceled)

7. A dragonfly-like miniature four-winged ornithopter, comprising a fuselage, two front flapping wings, two front wing connectors with first connecting rods, two rear flapping wings, two rear wing connectors with second connecting rods, a driving gear, a gear shaft, a first-stage gear, two second-stage gears with third connecting rods, two third-stage gears with fourth connecting rods, two front ball joint connecting rods, two rear ball joint connecting rods, two steering engine connecting rods, two steering engines, and a power which is a brushless direct current motor;
wherein the brushless direct current motor and the driving gear are fixedly connected and mounted at one side of the fuselage, the first-stage gear is meshed with the driving gear, the gear shaft is connected with the first-stage gear, two sides of the fuselage are respectively provided with the two second-stage gears engaged with the shaft gear, and respectively provided with the two third-stage gears which are engaged with the two second-stage gears respectively;
two front flapping wings are mounted at the two sides of a front part of the fuselage, and two rear flapping wings are mounted at the two sides of the fuselage at a rear part of the fuselage; each front flapping wing has only one degree-of-freedom of flapping around a first shaft, and each rear flapping ring has two degree-of-freedom of flapping around a second shaft and flipping front and back;
on each side of the fuselage, one end of a front ball joint connecting rod on the side is connected with a first connecting rod of a front wing connector on the side, and another end of the front ball joint connecting rod is connected with a fourth connecting rod of a third-stage gear on the side; one end of a rear ball joint connecting rod on the side is connected with a second connecting rod of a rear wing connector on the side, and another end of the rear ball joint connecting rod is connected with a third connecting rod of a second-stage gear on the side; and
one end of a steering engine connecting rod on the side is connected with a steering engine on the side, and another end of the steering engine connecting rod is connected with the rear wing connector on the side.

8. The dragonfly-like miniature four-winged ornithopter according to claim 7, wherein a gear ratio of the first-stage gear to the driving gear is 54:20.

9. The dragonfly-like miniature four-winged ornithopter according to claim 7, wherein a gear ratio of each second-stage gear to the gear shaft is 64:8.

10. The dragonfly-like miniature four-winged ornithopter according to claim 7, wherein a gear ratio of the third-stage gears to the second-stage gears is 1:1.

11. The dragonfly-like miniature four-winged ornithopter according to claim 7, further comprising a remote-control receiver, an electronic speed control, and a lithium battery, wherein the electronic speed control is connected with the lithium battery, the remote-control receiver, and the brushless direct current motor.

12. The dragonfly-like miniature four-winged ornithopter according to claim 7, wherein the micro ornithopter is made of carbon fiber or synthetic resin materials.
